(19) United States
(12) Patent Application Publication
(10) Pub. No.: US 2003/0227907 A1
(43) Pub. Date: Dec. 11, 2003

(54) Apparatus for providing QoS of VoIP traffic on IP router and forwarding method therefor

(76) Inventors: Gil-Young Choi, Daejon (KR); Jae-Woo Park, Daejon (KR); Kyou-Ho Lee, Daejon (KR); Hyeong-Ho Lee, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/265,532

(22) Filed: Oct. 7, 2002

(30) Foreign Application Priority Data
Jun. 8, 2002 (KR) 2002-32178

(51) Int. Cl. H04L 12/66; H04L 12/28

(52) U.S. Cl. 370/352; 370/401

(57) ABSTRACT

An apparatus for providing quality of service (QoS) of voice over IP (VoIP) traffic on IP routers and a forwarding method therefor are provided. The VoIP quality of QoS providing apparatus in an Internet protocol (IP) network containing data traffic and providing VoIP service includes: a softswitch which performs a VoIP call coordination function in the IP network and transmits VoIP call connection information in a multicast transmission method; and a router which provides QoS in forwarding a VoIP packet, by using the information received from the softswitch. With the VoIP QoS service providing apparatus, reliable multicast transmission method is enabled in providing VoIP connection information to each router, and when a softswitch additionally processes related functions, the load to the system is reduced. Since in the router, VoIP QoS flow and QoS information are added to a flow table for performing packet forwarding, VoIP packet recognition and QoS providing are enabled. In addition, flow management for providing QoS in a variety of shapes in the similar manner can be provided.

### BACKGROUND OF THE INVENTION

1. Field of the Invention

The present invention relates to providing Quality of Service (QoS) of voice traffic transmitted by a router when voice traffic converges on an Internet Protocol (IP) network, and more particularly, to an apparatus in which a router provides enough QoS to satisfy VoIP's demand, by receiving and managing information on VoIP flow from a softswitch and referring to the information in packet forwarding, and a packet forwarding method.

2. Description of the Related Art

Voice over IP (VoIP) service technologies have been developed and introduced as private network technologies for providing voice virtual private network (VPN) of major business subscribers. Accordingly, in order to provide VoIP services to a large number of ordinary subscribers, a lot of functions should be improved, and on top of this, there is Quality of Service(QoS). To provide QoS of VoIP, delay and delay variation should be minimized. However, in most of conventional routers forming IP networks, it is difficult to support QoS of VoIP at present. As a network apparatus for establishing a converged network supporting VoIP on IP networks, a softswitch has been developed to provide interoperability among VoIP signaling protocols. To provide QoS of VoIP as a whole, QoS should be first provided in the network level though improvement in terminal apparatuses is also needed. In the conventional routers forming a network, QoS as high as possible that can be provided by the routers should be allocated so that VoIP packets can be identified and recognized and QoS requested by VoIP can be provided. However, since in the router it is not easy to recognize VoIP packets due to IP protocol structures, it is difficult to provide QoS of VoIP in the network level.

### SUMMARY OF THE INVENTION

To solve the above problems, it is an object of the present invention to provide an apparatus for providing QoS of VoIP traffic on IP routers and a forwarding method in a router.

To solve the above problems, it is another object of the present invention to provide a computer readable medium having embodied thereon a computer program for the forwarding method.

According to an aspect of the present invention, there is provided a voice over IP (VoIP) quality of service (QoS) providing apparatus in an Internet protocol (IP) network containing data traffic and providing VoIP service, the VoIP QoS providing apparatus comprising: a softswitch which performs a VoIP call coordination function in the IP network and transmits VoIP call connection information in a multicast transmission method; and a router which provides QoS in forwarding a VoIP packet, by using the information received from the softswitch.

According to another aspect of the present invention, there is provided a packet forwarding method which provides QoS of VoIP traffic in an IP router, comprising: determining whether or not a received packet is included in information of the forwarding table of the router; checking whether or not the packet is a VoIP packet; setting a field value of an IP precedence in the format of an IP service type, to a predetermined value; and outputting a packet queued according to the precedence value.

### BRIEF DESCRIPTION OF THE DRAWINGS

The above objects and advantages of the present invention will become more apparent by describing in detail preferred embodiments thereof with reference to the attached drawings in which:

FIG. 1 is a schematic diagram showing an entire network structure to which the present invention is applied;

FIG. 2 is a block diagram of functional elements of a softswitch according to the present invention;

FIG. 3 is a block diagram of functional elements of a router according to the present invention;

FIG. 4 is a diagram of a structure in which connection establishment and/or termination information of VoIP call according to the present invention is transferred;

FIG. 5 is a diagram of a structure of message information communicated between a softswitch and a router according to the present invention;

FIGS. 6(a) and 6(b) show a preferred embodiment of an octet format of an IP service type according to the present invention; and

FIG. 7 is a flowchart showing a method for forwarding a packet in a router according to the present invention.

### DESCRIPTION OF THE PREFERRED EMBODIMENTS

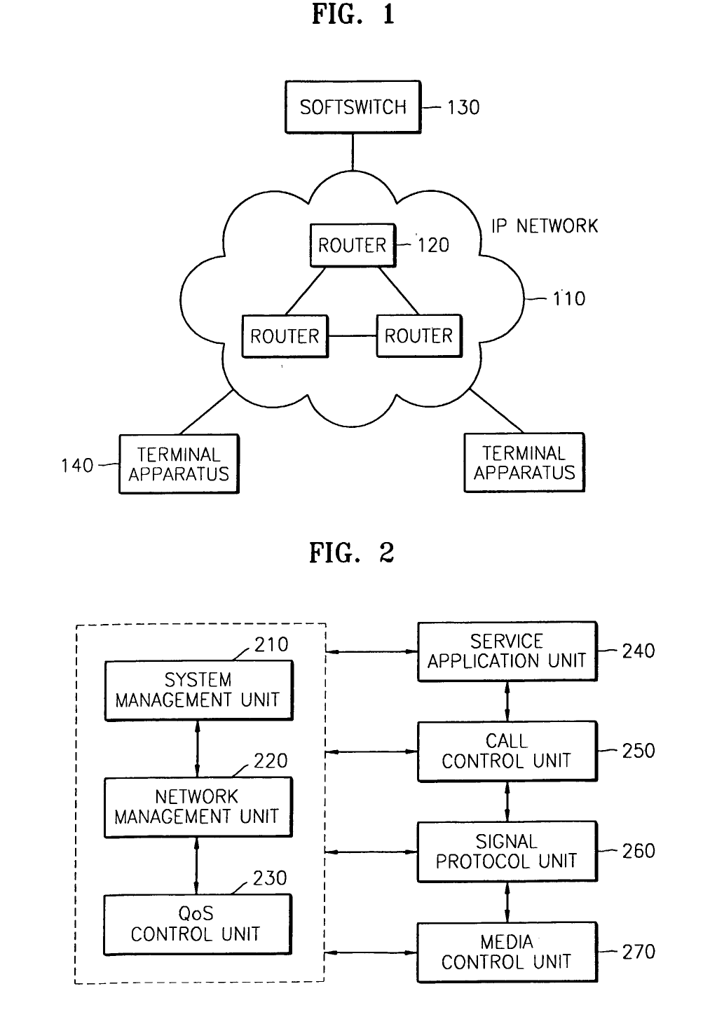

FIG. 1 is a schematic diagram showing the structure of an IP network to which the present invention is applied. The IP network 110 for providing VoIP services as well as conventional data traffic comprises routers 120 for routing among different sub networks and forwarding packets, a softswitch 130 which is connected to the IP network 110 and performs a connection function for VoIP signal protocols, and terminal apparatuses 140. According to the size of the network, one or more softswitches 130 may be placed.

FIG. 2 is a block diagram of functional elements of a softswitch according to the present invention.

A call control unit 250 unifies the functions of a call agent, a call server, a media gateway controller. A service application unit 240 introduces a connection function for different signal methods, and an open architecture so as to easily accommodate new services and to provide compatibility and interoperability. A signal protocol unit 260 provides an SS7 signal interface for VoIP signal protocols such as an H.323 or a Session Initiation Protocol (SIP), and for PSDN connection, and provides connection functions for IP networks. The softswitch also comprises a system management unit 210 which manages the entire system, a network management unit 220 which manages an IP network, and a QoS control unit 230 which performs a QoS control function.

Since the VoIP signaling protocol is an end-to-end type, in connection establishment and termination of a call which the router 120 in the softswitch 130 needs in providing flow classification of VoIP packets and QoS, VoIP flow information is transferred to the router 120. The QoS control module 203 performs this role as a whole. Call connection establishment and termination information includes the source IP address and destination IP address of an end-to-end VoIP call, UDP port numbers, etc.

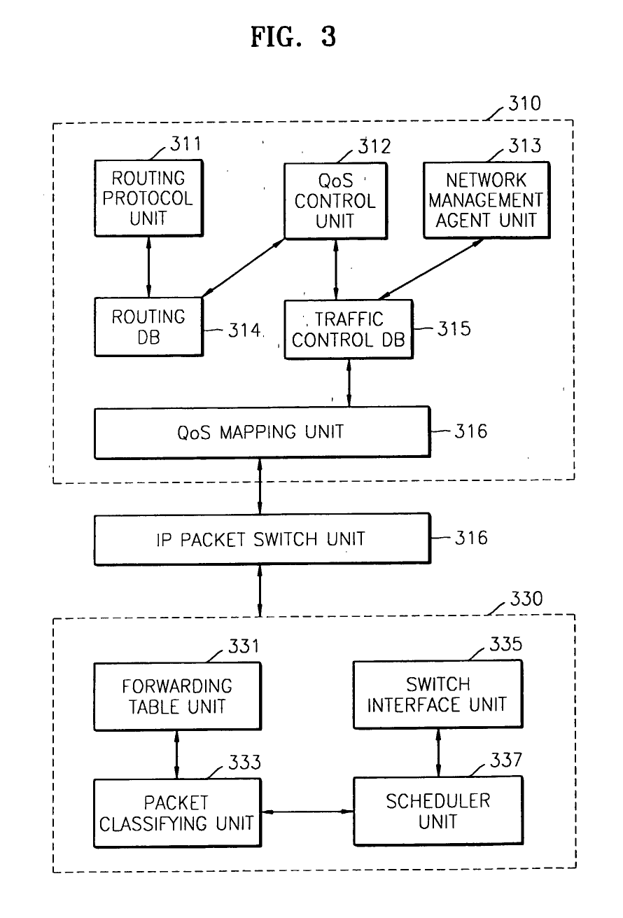

FIG. 3 is a block diagram of functional elements of a router according to the present invention, in which routing and forwarding are separated so that the router can operate at a speed of tens of gigabits per second.

A processor module 310 comprises a routing protocol unit 311 which performs routing protocols 304 such as RIP, OSPF, and BGP; a routing database (DB) 314 which maintains and manages routing table information; a QoS control unit 312 which performs a QoS control function; a network management agent unit 313 which performs a network management agent function 313; a traffic control database 315 which manages a traffic flow control table for providing QoS; and a QoS mapping unit 316 which relates to system resource management for providing QoS received from upper layers.

A line card 330 performs a packet forwarding function, in which a forwarding table unit 331 maintains a forwarding table restructured based on routing table information of the routing DB 314 in order to provide high speed forwarding, and a packet classifying unit 333 performs data packet classification and forwarding of received packets. A scheduler unit 337 performs precedence queueing for providing appropriate QoS to the classified packets and performs output scheduling according to the precedence queue. When an input packet is output through other line card 330, the packet is transferred to the softswitch 130 through a switch interface unit 335, and is forwarded to the network through the line card 330 of an output port.

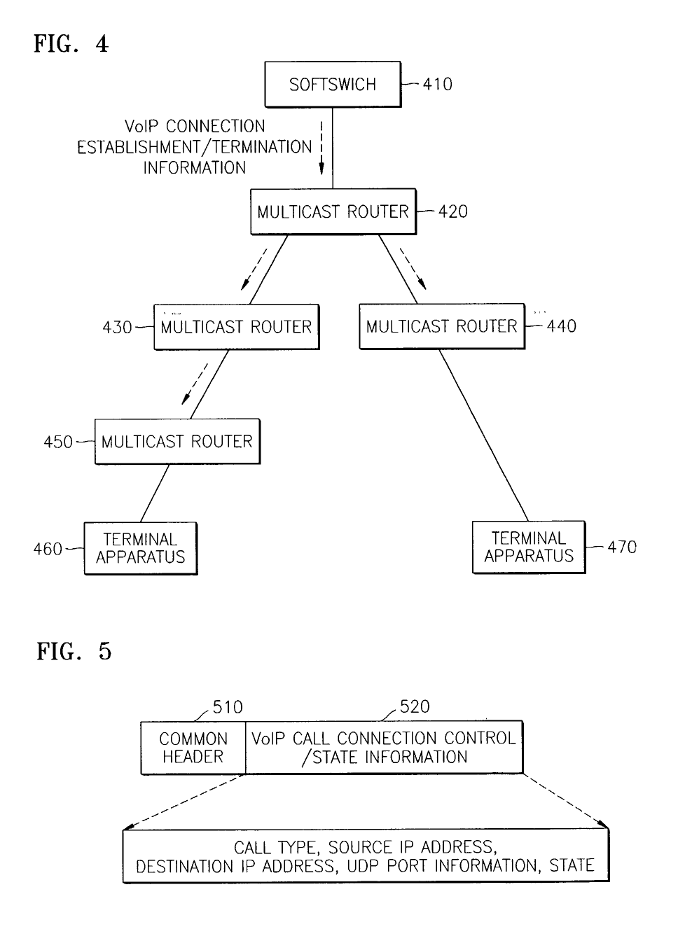

FIG. 4 is a diagram of a structure in which connection establishment and/or termination information of VoIP call according to the present invention is transferred.

A structure of transmitting VoIP call connection establishment and termination information between the softswitch 410 and routers 420 through 450 is based on multicast transmission and targets to minimize load to the system when the softswitch 410 transmits information. Here, by using a reliable multicast transmission method, all receivers should receive accurate data. For this, a transmitting side should be able to manage the state of a receiving side. All routers on a router path providing VoIP QoS should provide a multicast function and form a reliable multicast tree among routers. The softswitch 410 selects a representative receiving side for multicast transmission so that the representative receiving side can transmit data to all routers 420 through 450 that have to receive the data, through the multicast path. The routers 440 and 450 become able to recognize voice data packets transmitted and received by VoIP terminal apparatuses 460 and 470, and in order to provide QoS, precedence queueing and forwarding are provided.

The softswitch 410 and the routers 420 through 450 operate in a master-slave relation. First, in order to start functions, a process for establishing a connection for control is needed. If a multicast environment is supported, management for initial joining, including joining in a multicast group, is needed in routers that are clients. Based on thus established control information transmitting environment, information on VoIP sessions performed by the softswitch 410 or end-to-end call connections, including information on establishing a connection and terminating the connection, are transmitted to the routers 420 through 450 included in an object group performing a VoIP QoS management function. The routers 420 through 450, which receive this information, recognize the VoIP data packet by adding the packet to or deleting the packet in the flow table managed by each router, and processes the packet according to the precedence.

FIG. 5 is a diagram of a structure of message information communicated between a softswitch and a router according to the present invention.

Basically, the message comprises a common header 510 field and a VoIP call connection control/state information 520 field. The common header 510 field includes an operation code, the message length, etc. The VoIP call connection control/state information 520 field includes a call type (H.323, SIP, etc.), a source IP address, a destination IP address, a TCP/UDP port number, state information, or QoS information.

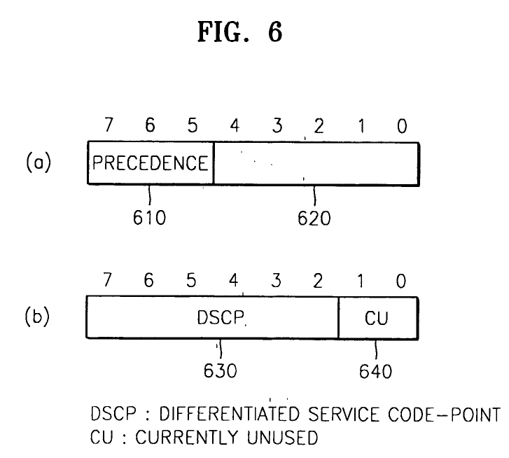

FIGS. 6(a) and 6(b) show a preferred embodiment of an octet format of an IP service type according to the present invention. In FIG. 6(a), the highest 3 bits in an octet format of a service type defined in the IP indicates IP precedence 610, in which, the greater the number is, the higher the precedence is. The next 4 bits indicates an additional service type, representing requirements such as delay, throughput, reliability, cost, etc. FIG. 6(b) shows a format defined to use the octet of the conventional IP service type, in order to provide differentiated services from the IP. Here, the conventional IP service octet is used without change. The highest 6 bits indicate a differentiated service code point (DSCP) 630, and overlaps the precedence field of the conventional IP. To solve this problem, some routers use a method in which in VoIP packet forwarding, DSCP value 40 (101000B) of FIG. 6(b) corresponding to the same value as the IP precedence value 5 (101 B) of FIG. 6(a) is used. A CU field 640 after the DSCP field 630 is 2-bits long and not used at present.

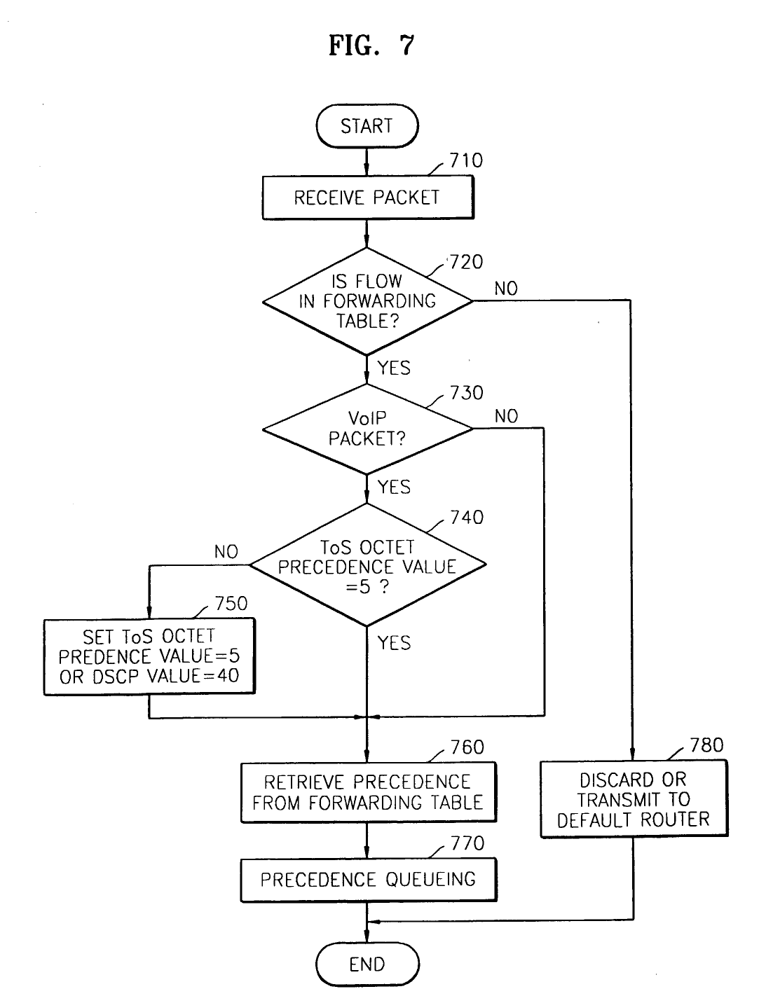

FIG. 7 is a flowchart showing a method for forwarding a packet in a router according to the present invention.

If the line card of a router receives a packet in step 710, by accessing the destination IP address of the IP header of the received packet in the forwarding table of the line card, it is first determined whether or not there is a next hop to be transmitted in step 720. If it is a flow which does not exist, the packet is discarded or forwarded to a default router in step 780. If it is a flow in the table, it is determined whether or not it is a VoIP packet in step 730. If it is a VoIP packet, it is determined whether or not the IP precedence field value of the ToS octet is 5 in step 740, and if it is not 5, set the field value to 5 or change the DSCP value to 40 in step 750. Precedence value corresponding to the flow is accessed in the forwarding table in step 760 and according to the obtained precedence, the packet is queued in step 770. The packets queued according to the precedence is output according to the precedence by the scheduler. That is, the first ingress router to which the VoIP packet is transmitted makes the routers in the middle nodes check the service type field to recognize a VoIP packet flow. In a method, by recognizing a VoIP flow only with the precedence of the service type, a high precedence transmission is performed. In another method, by confirming VoIP call connection information obtained from additional communications with the softswitch, a stable precedence transmission performed. The routes in the middle nodes are made to use one of two selective methods.

The present invention may be embodied in a code, which can be read by a computer, on a computer readable recording medium. The computer readable recording medium includes all kinds of recording apparatuses on which computer readable data are stored.

The computer readable recording media includes storage media such as magnetic storage media (e.g., ROM's, floppy disks, hard disks, etc.), optically readable media (e.g., CD-ROMs, DVDs, etc.) and carrier waves (e.g., transmissions over the Internet). Also, the computer readable recording media can be scattered on computer systems connected through a network and can store and execute a computer readable code in a distributed mode.

As described above, according to the present invention, the softswitch provides VoIP call connection information to routers, and by using this, the routers can recognize a VoIP packet and provide QoS. In providing VoIP connection information to each router, reliable multicast transmission method is used such that load to the system is reduced when the softswitch additionally processes related function. Since in the router, VoIP QoS flow and QoS information are added to a flow table for performing packet forwarding, VoIP packet recognition and QoS providing are enabled. In addition, flow management for providing QoS in a variety of shapes in the similar manner can be provided.

What is claimed is:

1. A voice over IP (VoIP) quality of service (QoS) providing apparatus in an Internet protocol (IP) network containing data traffic and providing VoIP service, the VoIP QoS providing apparatus comprising:
a softswitch which performs a VoIP call coordination function in the IP network and transmits VoIP call connection information in a reliable multicast transmission method; and
a router which provides QoS in forwarding a VoIP packet, by using the information received from the softswitch.

2. The apparatus of claim 1, wherein the softswitch comprises:
a call control unit which unifies the functions of a call agent, a call server, and a media gateway control;
a signaling protocol unit which provides a signaling interface for connecting a VoIP signaling protocol and a public switched data network (PSDN); and
a control unit which performs functions for system management, network management, and QoS control.

3. The apparatus of claim 2, wherein the VoIP signal protocol is an end-to-end flow, and the signal protocol unit transmits information on establishing or terminating a call connection, including IP addresses of source and destination of an end-to-end VoIP call, and UDP port number, that are needed when the router provides flow classification of VoIP packets and QoS.

4. The apparatus of claim 1, wherein the router comprises:
a processor module unit which performs a routing protocol and manages information on a routing table;
a line card unit which performs packet forwarding, forms a forwarding table from the information on a routing table, and uses the forwarding table in packet classification and forwarding; and
an IP packet switch unit which connects the processor module unit and the line card unit for high speed switching.

5. A packet forwarding method which provides QoS of VoIP traffic in an IP router, comprising:
determining whether or not a received packet is included in information of the forwarding table of the router;
checking whether or not the packet is a VoIP packet;
setting a field value of an IP precedence in the format of an IP service type, to a predetermined value; and
outputting a packet queued according to the precedence value.

6. The method of claim 5, wherein in the determining, it is determined whether or not there is a hop to be transmitted, by accessing the IP address of the destination of the received packet in the forwarding table.

7. The method of claim 5, wherein in setting a field value, if it is determined that the packet is a VoIP packet, it is determined whether or not the field value of the IP precedence of the service type octet is 5, and if the field value is not 5, the field value is set to 5 and queueing according to the precedence is performed.

8. The method of claim 5, wherein in setting a field value, the highest 3 bits in the format of the service type octet indicates an IP precedence, and the next 4 bits indicate delay, throughput, reliability, and cost.

9. A computer readable medium having embodied thereon a computer program for any one of claims 5 through 8.
